(19) United States
(12) Patent Application Publication
(10) Pub. No.: US 2024/0207729 A1
(43) Pub. Date: Jun. 27, 2024

(54) GAME CONTROLLER MOBILE BRIDGE

(71) Applicant: GOOGLE LLC, Mountain View, CA (US)

(72) Inventors: John Thomas McDole, Sunnyvale, CA (US); Matt Joseph, San Francisco, CA (US)

(21) Appl. No.: 18/557,665

(22) PCT Filed: Nov. 19, 2021
(86) PCT No.: PCT/US2021/060051

§ 371 Date: Oct. 27, 2023

Related U.S. Application Data
(60) Provisional application No. 63/246,419, filed on Sep. 21, 2021.

(51) Int. Cl. A63F 13/352; A63F 13/23; A63F 13/355; A63F 13/92

(52) U.S. Cl. CPC A63F 13/352; A63F 13/23; A63F 13/355; A63F 13/92; A63F 2300/308; A63F 2300/538

(57) ABSTRACT

A bridge device communicatively coupled to an input device generates a device pair request associated with a client gaming session and transmits the device pair request to a device discovery engine operating on one or more servers. Based on the device pair request, the device discovery engine identifies one or more servers running a gaming application supporting the client gaming session. The device discovery engine then generates a linking code identifying and allowing access to the servers. In response to receiving the linking code. the bridge device establishes a connection between one or more input devices communicatively connected to the bridge device and the identified servers running the gaming application. The bridge device maintains the connection for at least a portion of the client gaming session such that data representing interactions received at the input devices is provided to the servers for use as inputs to the gaming application.

### BACKGROUND

Conventionally, video games run on local hardware connected with local game controller devices via wired or local network methods. However, through cloud-based gaming services, video games can run at locations that are not local to the user which can disconnect games from readily available connectivity layers for game controllers. Additionally, through cloud-based gaming services, games are run on devices not originally envisioned for gaming, further limiting the available connections for game controllers. Such a lack of connectivity for game controllers can lead to a user not having an input device compatible with one or more cloud-based gaming services. To address the lack of game controller availability, connectivity solutions have been developed using mobile devices as the source of control. However, such solutions can be insufficient for a cloud-based gaming system because cloud-based gaming systems rely on local network connectivity to control the user interface portion of the video game platform experience.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a cloud-based gaming system employing an input device pairing technique, in accordance with some embodiments.

FIG. 2 is a block diagram of a bridge device configured to pair one or more input devices with one or more gamelet servers, in accordance with some embodiments.

FIG. 3 is a block diagram of an example controller graphical user interface, in accordance with an example embodiment.

FIG. 4 is a block diagram illustrating an example system for physical input device pairing for cloud-based gaming, in accordance with an example embodiment.

FIG. 5 is a block diagram illustrating an example system for virtual input device pairing for cloud-based gaming, in accordance with an example embodiment.

FIGS. 6 to 8 are signal flow diagrams together illustrating an example pairing operation for pairing one or more input devices with one or more gamelet servers, in accordance with an example embodiment.

FIG. 9 is a flow chart illustrating an example method for pairing one or more input devices with one or more gamelet servers, in accordance with an example embodiment.

### SUMMARY OF EMBODIMENTS

According to an example embodiment, a method for cloud-based gaming can include communicatively coupling at least one physical game controller to a bridge device that can be configured to pair the at least one physical game controller with at least one cloud-based gaming server. The method can also include transmitting, (e.g., from the bridge device) to the at least one cloud-based gaming server, a device pair request to establish the at least one physical game controller as an input device for a gaming application running on the at least one cloud-based gaming server and also associated with a client gaming session. In response to receiving a linking code (e.g., from the cloud-based gaming server and by the bridge device), the method can further include maintaining, for at least a portion of the client gaming session, a connection between the at least one physical game controller and the at least one cloud-based gaming server so that data representing one or more interactions with the at least one physical game controller is provided to the at least one cloud-based gaming server for use as inputs to the gaming application.

In an example embodiment, the bridge device may be communicatively coupled to the at least an input device and may generate the device pair request associated with a current client gaming session. The bridge device can transmit the device pair request to a device discovery engine operating on the one or more cloud-based gaming servers. Based on the device pair request, the device discovery engine can identify one or more gaming servers running the gaming application to support the current client gaming session. In response to identifying the game servers, the device discovery engine may generate the linking code identifying the game server(s) and allowing access to the game server(s). In response to the linking code being received by the bridge device, the bridge device can establish a connection between one or more input devices communicatively connected to the bridge device and the identified game server(s) running the gaming application. The bridge device may maintain the connection for at least a portion of the client gaming session such that data representing interactions received at the input devices is provided to the servers for use as inputs to the gaming application.

In the method, the bridge device can include a smartphone. The method can additionally include communicatively coupling a client system associated with the client gaming session to the bridge device. Further, the method can include transmitting data representing an interaction with the at least one physical game controller to the client system associated with the client gaming session. In response to receiving the interaction with the at least one physical game controller, the method can also include modifying a graphical user interface displayed on the client system. The method may further include determining one or more client system inputs based on the interaction with the at least one physical game controller.

Also, the method can include receiving a linking code associated with the cloud-based gaming server and establishing the connection between the at least one physical game controller and the at least one cloud-based gaming server based on the linking code. Additionally, the method may include receiving data representing an interaction with the at least one physical game controller indicating the linking code. Further, the method can include determining one or more game inputs based on the data representing one or more interactions with the at least one physical game controller and providing the game inputs to the at least one cloud-based gaming server.

In another example embodiment, a method for cloud-based gaming can include receiving, at at least one cloud-based gaming server, a device pair request associated with a client gaming session from a bridge device communicatively coupled to at least one physical game controller. Further, the method can include identifying, among the least one cloud-based gaming server, at least one gamelet server running a gaming application to support the client gaming session. Additionally, the method can include pairing the identified at least one gamelet server with the at least one physical game controller such that data representing one or more interactions with the at least one physical game controller is provided to the at least one gamelet server for use as inputs to the gaming application running on the at least one gamelet server.

In the method, in response to receiving a client gaming session request, the method may also include launching the client gaming session. Launching the client gaming session includes, for example, running the gaming application on the at least one gamelet server. Further, the method can include rendering a plurality of game frames associated with the gaming application and encoding the plurality of game frames to produce a game stream. Additionally, the method can include transmitting the game stream to a client system associated with the client gaming session.

As well, the method can include modifying the gaming application running on the at least one gamelet server based on the data representing one or more interactions with the at least one physical game controller. Modifying the gaming application may include providing data representing an interaction received by the at least one physical game controller as an input to a calculation of the gaming application. In response to receiving data representing an interaction with the at least one physical game controller, the method can further include suspending the gaming application.

The method may also include rendering a plurality of modified game frames based on the data representing one or more interactions with the at least one physical game controller and encoding the plurality of modified game frames to produce a modified game stream. Further, the method can include transmitting the modified game stream to a client system associated with the client gaming session. As well, the method can include generating a linking code (e.g, by a device discovery engine of the gaming system) based on the identified at least one gamelet server. In the method, pairing the identified at least one gamelet server with the at least one physical game controller may be based on the linking code. Based on the device pair request and by a device discovery engine of the cloud-based gaming system, one or more gamelet servers of the cloud-based gaming system running the gaming application may be identified to support the client gaming session. The device discovery engine may generate the linking code identifying the one or more gamelet servers and allowing access to at least a portion of the one or more gamelet servers. Therefore, the linking code may include network location information of the identified gamelet servers, for example, at least one network address or network port address (e.g., IP address, MAC address port) of the identified one or more gamelet servers.

In general, the device pair request can include data identifying the gaming application associated with the client gaming session. Further, the device pair request can include data identifying the at least one physical game controller. The at least one physical game controller can also include a gamepad, a keyboard, a mouse, or any combination thereof.

According to example embodiments, a cloud-based gaming system comprises at least one cloud-based gaming server; at least one physical game controller; a bridge device communicatively coupled to the at least one physical game controller; one or more processors; and a memory coupled to the one or more processors and storing executable instructions configured to manipulate the one or more processors to perform a proposed method.

For example, the cloud-based gaming system may include a game controller mobile bridge device including one or more processors and a memory coupled to the one or more processors. The memory can store executable instructions configured to manipulate the one or more processors to perform the methods disclosed herein.

In additional embodiments, the cloud-based gaming system can additionally include a network interface coupleable to a network. The gaming system can be configured to perform the methods disclosed herein.

### DETAILED DESCRIPTION

Techniques and systems described herein address the demands of providing connectivity for user input devices within a cloud-based gaming system. In particular, such techniques and systems described herein allow for one or more input devices to be paired with a server running a gaming application so that interactions received at the input devices are provided as inputs to the gaming application. To pair the input devices to the servers, a bridge device communicatively coupled to the input devices generates a device pair request associated with a current client gaming session to establish a connection between the input devices and the servers. The bridge device transmits the device pair request to a device discovery engine operating on one or more servers of the cloud-based gaming system. Based on the device pair request, the device discovery engine identifies one or more servers of the cloud-based gaming system running a gaming application to support the current client gaming session. In response to identifying the servers, the device discovery engine generates a linking code identifying the servers and allowing access to the servers. In response to the linking code being received by the bridge device, the bridge device establishes a connection between one or more input devices communicatively connected to the bridge device and the identified servers running the gaming application. The bridge device maintains the connection for at least a portion of the client gaming session such that data representing interactions received at the input devices is provided to the servers for use as inputs to the gaming application. In this way, connectivity for the input devices is provided as the connection provided by the bridge device allows the input devices to function as input devices for the servers running the gaming application.

To facilitate understanding, the techniques of the present disclosure are described in the example context of a cloud gaming system. A cloud-based server or other remote server renders a stream of video frames representing the visual content of a video game instance being executed at that server or a related server and then encodes each frame to generate a bitstream representing a stream of encoded rendered game frames for transmission to one or more client systems via one or more networks. However, it will be appreciated that the systems and techniques described herein are not limited to this example context, but instead may be implemented in any of a variety of video stream encoding/decoding systems using the guidelines provided herein.

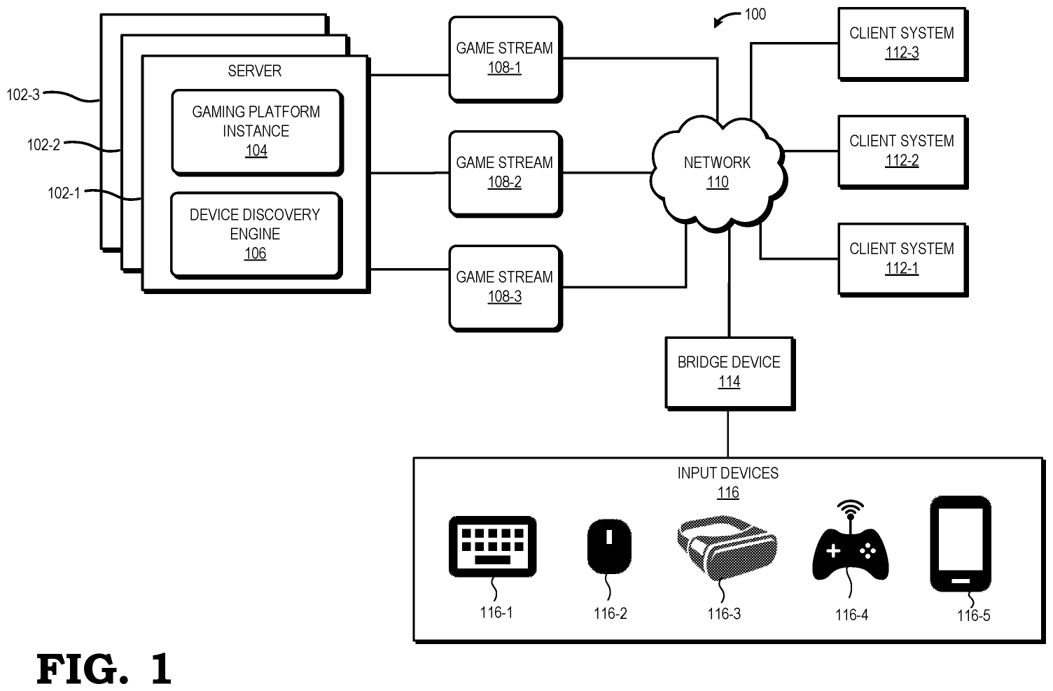

FIG. 1 illustrates a cloud-based gaming system 100 for single-player or multiplayer (including massively multiplayer) gaming, according to some embodiments. Cloud-based gaming system 100 includes one or more cloud-based gaming servers 102, with each server 102 communicatively coupled to one or more client systems 112 by at least one network 110. The servers 102 and the one or more client systems 112 can be communicatively coupled via one or more of wired communications, wireless communications, and the like. Network 110 is configured to allow for the transmission and reception of data between any of servers 102 and client systems 112 and includes, for example, wired and wireless networks, such as Ethernet, the Internet, Wi-Fi, or any combination thereof. In embodiments, each server 102 is communicatively interconnected via a high-bandwidth, low-latency inter-server messaging bus. Servers 102 are typically distributed in one or more data centers over a geographical area so as to reduce transmission latency through physical proximity. Though in the illustrated embodiment, three servers 102-1, 102-2, and 102-3 are presented supporting three client systems 112-1, 112-2, and 112-3, in other embodiments, any number of servers may be implemented supporting any number of client systems. It will be appreciated that in a typical real-world implementation, the quantity of servers 102 and quantity of client systems 112 typically will be considerably higher than presented in the example of FIG. 1.

In the depicted embodiment, each server 102 includes a computing device such as, for example, a cloud server, virtual server, or any combination thereof configured to support one or more client gaming sessions executed on one or more client systems 112. A “client gaming session”, as used herein, includes a gaming application being played, partially simulated, or fully simulated on client system 112. Each server 102 is configured to support this client gaming session by executing a corresponding gaming platform instance 104 that facilitates the execution of at least a portion of the gaming application being played, partially simulated, or fully simulated on the client system 112. Such facilitation can include performing one or more operations related to the gaming application, such as, for example, rendering one or more frames related to the gaming application, performing calculations related to the gaming application (e.g., lighting calculations, artificial intelligence calculation, physics calculations, shading calculations, input calculations, and the like), providing access to files, or any combination thereof, to name a few. The gaming platform instance 104 provides various software and hardware resources to achieve such facilitation, such as communication/network management, resource management, media rendering encoding, and the like. In this way, gaming platform instance 104 simulates the execution of one or more operations of gaming application for a corresponding player as though that gaming application was being played on a local gaming device, such as a personal computer (“PC”), game console, smartphone, tablet computer, automotive entertainment system, and the like.

Each client system 112 represents the hardware and software resources utilized to present the video and audio content representing the visual and auditory content, respectively, of the gameplay for the at least one player. Examples of a client system 112 include one or more desktop computers, notebook computers, tablet computers, virtual-reality systems, augmented reality systems, a compute-enabled cellular phone (i.e., a “smartphone”), a compute-enabled television (i.e., a “smart TV”), or any combination thereof, to name a few. In embodiments, each client system 112 includes one or more client devices. As an example, a client system 112 comprises a first client device, which is communicatively coupled to, or otherwise associated with, a display, one or more network interfaces configured to couple to the network connecting the client system 112 to a corresponding server 102, one or more processors, memory, storage, speakers, and other computing resources to render, process, and display scenes of a virtual environment. In embodiments, each client system 112 can include a decoder configured to decode one or more frames related to a virtual environment. Each decoder can include hardware and software configured to decode one or more encoding streams (e.g., game streams 108) received from servers 102 so as to produce a decoded set of frames or decoded stream. Each decoder is configured to decode any encoded frame encoded by any method or process disclosed herein. In embodiments, a client system 112 further includes, for example, a smartphone client device, a wearable virtual reality client device, or both, each of which may operate as an integrated mobile computing device having input facilities, output facilities, display facilities, and communication facilities analogous to those noted above with respect to a respective client system. In certain embodiments, client systems 112-1, 112-2, and 112-3 may include one or more facilities such as accelerometers, inertial measurement units (IMUs), Global Positioning System (GPS) devices, and the like, that are used to acquire motion data representing movement of the client device, as well as a rate or acceleration of such movement.

In embodiments, one or more client systems 112 are communicatively coupled to one or more input devices 116 by one or more bridge devices 114. A bridge device 114 includes hardware and software (e.g., smartphone, tablet, notebook computer, desktop computer, smart TV) configured to communicatively couple, pair, or associate input devices 116 with one or more client systems 112, one or more client gaming sessions, or both. Such input devices 116 are configured to receive one or more interactions and include, for example, keyboards 116-1, mice 116-2, wearable virtual reality client devices 116-3 (e.g., a virtual reality headset, virtual reality controllers, virtual reality beacons), game controllers 116-4 (e.g., gamepads, joysticks, light guns, steering wheels, arcade sticks, adaptive game controllers, accessibility controllers), and smartphones 116-5. Interactions received by input devices 116 include, for example, gestures on a touch screen, button presses, joystick movements (e.g., tilts, rotations), keystrokes, mouse clicks, mouse drags, device movements (e.g., device rotations), to name a few.

According to embodiments, a bridge device 114 is configured to communicatively couple one or more input devices 116 to a bridge device 114 using a first communication protocol and one or more client systems 112 to a bridge device 114 using one or more second communication protocols such that the input devices 116 and client systems 112 are communicatively coupled. Such communication protocols include one or more wired, wireless, or both communication protocols, for example, ethernet, RS-232, PS/2, USB, Thunderbolt, Bluetooth, Bluetooth low energy (BLE), near-field communication (NFC), radio frequency (RF) protocols, Wi-Fi, or any combination thereof, to name a few. For example, bridge device 114 is configured to communicatively couple to a game controller 116-4 using a USB communication protocol and to a client system 112 using an Ethernet communication protocol. As another example, bridge device 114 is configured to communicatively couple to a keyboard using a Bluetooth communication protocol and to a client system 112 using an RF communication protocol. In embodiments, a bridge device 114 is configured to communicatively couple to one or more input devices 116 and to one or more client systems 112 such that interactions received at the input devices 116 are provided to the client systems 112 as inputs. For example, when a bridge device 114 is communicatively coupled to one or more input devices 116 and one or more client systems 112, the bridge device 114 provides data representing interactions received at the input devices 116 to one or more of the client systems 112. Based on the provided data representing interactions, a client system 112 launches, modifies, or ends one or more applications, client gaming sessions, or both on the client system 112. For example, based on the provided data representing interactions, a client system 112 launches a client gaming session, modifies a graphical user interface, or any combination thereof.

One or more bridge devices 114 are configured to communicatively couple, pair, or associate one or more input devices 116 with one or more client gaming sessions associated with one or more client systems 112 communicatively coupled to the bridge devices 114. For example, one or more bridge devices 114 are configured to communicatively couple, pair, or associate one or more input devices 116 with a server 102 running a gaming platform instance 104 to support a client gaming session running on a client system 112 communicatively coupled to the bridge devices 114. In embodiments, a bridge device 114 is configured to communicatively couple, pair, or associate one or more input devices 116 with a server 102 by sending a device pair request including identification data to one or more device discovery engines 106 running on one or more servers 102. A “device discovery engine,” as used herein, includes hardware and software configured to identify and allow access to one or more servers 102 running a gaming application on a gaming platform instance 104 to support a client gaming session. As used herein, servers 102 running a gaming application on a gaming platform instance 104 to support a client gaming session are also referred to a “gamelet servers”. In embodiments, a device discovery engine 106 is configured to identify and allow access to servers 102 running a gaming application on a gaming platform instance 104 to support a client gaming session (i.e., gamelet servers) based on the identification data received from a bridge device 114 communicatively coupled to the input devices 116. Such identification data includes, for example, identification numbers (e.g., device identification numbers, serial numbers), client gaming session identifiers (e.g., user IDs, game application information), internet protocol (IP) addresses, media access control (MAC) addresses, or any combination thereof associated with one or more input devices 116, bridge devices 114, client gaming sessions, or any combination thereof. For example, based on the received identification information, a device discovery engine 106 identifies one or more gamelet servers 102 associated with a specified client gaming session. In embodiments, in response to identifying one or more gamelet servers 102, a device discovery engine generates a linking code that allows access to at least a portion of the identified gamelet servers 102.

According to embodiments, in response to receiving a linking code, bridge device 114 is configured to pair one or more input devices 116 with one or more gamelet servers 102 such that interactions received at the input devices 116 are provided as inputs to the gamelet servers. That is to say, bridge device 114 maintains a connection between the input devices 116 and the gamelet servers 102 so that data representing one or more interactions with the input devices 116 is provided to the gamelet servers 102 for use as inputs to gaming applications running on the gamelet servers 102. For example, bridge device 114 provides data representing interactions received at the input devices 116 to a gamelet server 102 running a gaming application on a gaming platform instance 104. In embodiments, bridge device 114 maintains the pairing, or connection, between the input devices 116 and gamelet servers 102 for at least a portion of a client gaming session associated with one or more client systems 112 communicatively coupled to the bridge device 114 and support by the gamelet servers 102.

In response to receiving the data representing interactions received at the input devices 116, a gamelet server 102 is configured to modify at least a portion of a gaming application running on a gaming platform instance 104 based on the data representing interactions received at the input devices 116. For example, in response to receiving the data representing interactions received at the input devices 116, the gamelet server 102 is configured to modify the frames rendered by the gaming platform instance 104 based on the data representing interactions received at the input devices 116. As another example, in response to receiving the data representing interactions received at the input devices 116, the gamelet server 102 is configured to modify calculations related to the gaming application running on gaming platform instance 104 based on data representing interactions received at the input devices 116. In this way, bridge device 114 pairs the input devices 116 and gamelet servers 102 such that the input devices 116 function as direct input devices (e.g., game controllers) for the applications running of the gamelet servers 102.

While certain aspects described herein will be discussed with specific reference to cloud gaming scenarios, it will be appreciated that in certain embodiments the described techniques may be utilized in various non-gaming scenarios, such as if one or more of servers 102 and client systems 112 operate to render, process, and display other types of informational, educational, recreational and/or artistic content. It will therefore be further appreciated that while techniques are discussed herein with respect to the rendering of content that may utilize particular examples relevant to cloud gaming and gaming content, such discussions and techniques may be applied to such non-gaming scenarios. Examples provided herein may refer to scenarios involving the rendering, processing, and display of gaming content due to particular bandwidth and network latency issues relevant to such content and should not be construed to indicate that the techniques described are limited to those scenarios.

During operation, each server 102 executes a gaming platform instance 104 for one or more client gaming sessions. Executing gaming platform instance 104 includes rendering a set of frames that includes one or more game frames associated with the gaming application being executed on one or more respective client systems 112. Each rendered game frame depicts at least a portion of a virtual environment used in the gaming application executed on the client system 112. For example, each rendered game frame can depict at least a portion of a virtual environment displayed on a display of a client system 112 during the client gaming session.

Each server 102 is configured to encode each rendered game frame via encoder to generate a respective encoded set of frames (also referred to herein as “game stream” 108). Each server 102 is configured to encode a game stream 108 through, for example, compression, reorganization, and manipulation of each frame rendered by gaming platform instance 104. In embodiments, each encoder of a server 102 implements one or more codecs so as to encode one or more rendered frames according to the one or more codecs. Such codecs can include H.264, H.265, VP9, AV1, or any combination thereof, to name a few. Each resulting game stream 108 corresponds to a gaming application being executed on one or more client systems 112 and is provided to these corresponding client systems via network 110. The corresponding client systems 112 are each configured to decode a received game stream 108 via a decoder and display the resulting decoded set of frames on, for example, a display. Each client system 112 is configured to decode a respective game stream 108 by compression, reorganization, and manipulation of the frames within the encoded stream according to one or more various video codecs including lossless and lossy codecs. According to embodiments, each client system 112 includes a decoder that implements one or more codecs so as to decode a received game stream 108 according to the one or more codecs. Such codecs can include H.264, H.265, VP9, AV1, or any combination thereof, to name a few. Though three game streams 108-1, 108-2, 108-3 are depicted in the illustrated embodiment, in other embodiments, servers 102 can generate any number of game streams 108 each corresponding to one or more client gaming sessions.

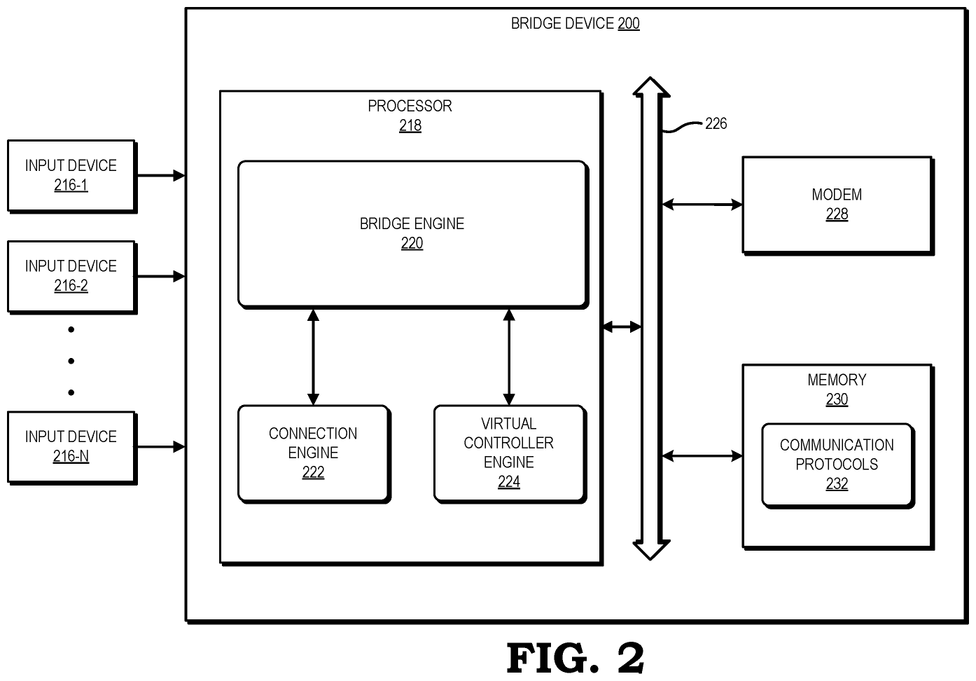

Referring now to FIG. 2, bridge device 200 configured to communicatively couple one or more input devices to one or more client systems, one or more gamelet servers, or both is illustrated. In embodiments, bridge device 200 implements aspects of cloud-based gaming system 100 as described in FIG. 1. For example, bridge device 200 may be similar or the same as a bridge device 114 described in FIG. 1. Bridge device 200 includes one or more software and hardware components for bi-directional communications including components for communicatively coupling one or more input devices 216, similar to or the same as input devices 116, to one or more client systems, similar to or the same as client systems 112, such that interactions received by the input devices 216 are received by the client systems. Additionally, bridge device 200 includes one or more software and hardware components for bi-directional communications including components for communicatively coupling one or more input devices 216 to one or more gamelet servers, similar to or the same as servers 102, such that interactions received by the input devices 216 are received by the gamelet servers. Such hardware and software include, for example, a smartphone, a desktop computer, a notebook computer, a tablet, a server, to name a few. As an example, bridge device 200 includes a smartphone running an application configured to communicatively couple one or more input devices 216 to one or more client systems, gamelet servers, or both. In embodiments, bridge device 200 includes processor 218, modem 228, and memory 230. Memory 230 includes an electronic storage device, such as for example, a solid-state drive, a hard disk drive, random access memory (“RAM”), read-only memory (“ROM”), electronically erasable programmable ROM (“EEPROM”), optical storage device, or any combination thereof. Memory 230 includes instructions and data related to the operation of bridge engine 220, connection engine 222, and virtual controller engine 224, for example, communication protocols 232. Modem 228 is configured to be communicatively coupled to one or more client systems 112, one or more servers 102 (e.g., gamelet servers), or both via a network 110 and further configured to provide interactions received at one or more input devices to the one or more client systems 112 and gamelet servers. According to embodiments, processor 218, modem 228, and memory 230 are internally in electronic communication via one or more interfaces (e.g., a bus 226).

According to embodiments, processor 218 includes one or more control processing units (“CPUs”), microprocessors, field-programmable gate arrays (“FPGAs”), graphics processing units (“GPUs”), application-specific integrated circuits (ASICs), or any combination thereof and is configured communicatively couple one or more input devices 216 to one or more client systems, gamelet servers, or both within system 100. Processor 218 executes to operate a connection engine 222 including hardware and software configured to communicatively couple one or more input devices 216 to bridging device 200. In embodiments, connection engine 222 is configured to communicatively couple one or more input devices 216 to bridge device 200 using one or more wired, wireless, or both, communication protocols 232, for example, ethernet, RS-232, PS/2, USB, Thunderbolt, Bluetooth, BLE, NFC, RF protocols, Wi-Fi, or any combination thereof, to name a few. For example, connection engine 222 is configured to communicatively couple input device 216-1 to bridge device 200 using USB. As another example, connection engine 222 is configured to communicatively couple input device 216-2 to bridge device 200 using RF protocols. According to embodiments, bridge 200 includes one or more ports (now shown for clarity) associated with one or more communication protocols, for example, USB (e.g., USB Micro-B, USB Mini-B, USB-C), PS/2, Thunderbolt, RS-232) used by communication engine 222 to communicatively couple one or more input devices 216 to bridge device 200. Though in the illustrative embodiment of FIG. 2 three input devices (216-1, 216-2, 216-N) are presented representing an N number of input devices communicatively coupled to bridge device 200, in other embodiments, any number of input devices 216 may be communicatively coupled to bridge device 200. According to embodiments, connection engine 222 is configured to communicatively couple bridge device 200 to one or more client systems 112. For example, connection engine 222 is configured to communicatively couple bridge device 200 to one or more client systems 112 using one or more wired, wireless, or both, communication protocols 232, for example, ethernet, RS-232, PS/2, USB, Thunderbolt, Bluetooth, BLE, NFC, RF protocols, Wi-Fi, or any combination thereof, to name a few. As an example, connection engine 222 is configured to communicatively couple bridge device 200 to a client system 112 using Bluetooth.

In response to connection engine 222 communicatively coupling one or more input devices 216 and one or more client systems 112 to bridge device 200, processor 218 executes to operate a bridge engine 220 including hardware and software configured to provide one or more interactions received at one or more input devices 216 communicatively coupled to bridge device 200 as inputs to one or more communicatively coupled client systems 112. Such interactions received by input devices 216 include, for example, gestures on a touch screen, button presses, joystick movements (e.g., tilts, rotations), keystrokes, mouse clicks, mouse drags, device movements (e.g., device rotations), to name a few. According to embodiments, in response to receiving one or more respective interactions, each input device 216 communicatively coupled to bridge device 200 provides data representing the respective interactions to bridge engine 220. For example, in response to receiving a button press, input device 216 provides data representing the button press to bridge engine 220. In embodiments, in response to receiving data representing one or more interactions from the input devices 216, bridge engine 220 provides one or more client system inputs to one or more client systems 112 communicatively coupled to bridge device 200. “Client system inputs,” as used herein, include data representing one or more interactions received by one or more input devices 216, application inputs (e.g., data used in calculations of an application, data used in operations of an application), application commands (e.g., launch application, end application, suspend application), client system commands (e.g., power down, enter sleep state, restart), or any combination thereof. According to embodiments, bridge engine 220 determines one or more client system inputs based on data representing one or more interactions from the input devices 216. For example, bridge engine 220 provides data representing one or more interactions from the input devices 216 to one or more software or hardware lookup tables configured to identify one or more client system inputs. As another example, bridge engine 220 compares data representing one or more interactions from the input devices 216 to data stored in one or more tables, databases, or both, and determines one or more client system inputs based on the comparison. In response to receiving the client system inputs, a client system 112 is configured to modify applications running on the client system, alter a graphical user interface (GUI) rendered and displayed by the client system, launch a client gaming session, launch an input device mobile bridge session, or any combination thereof.

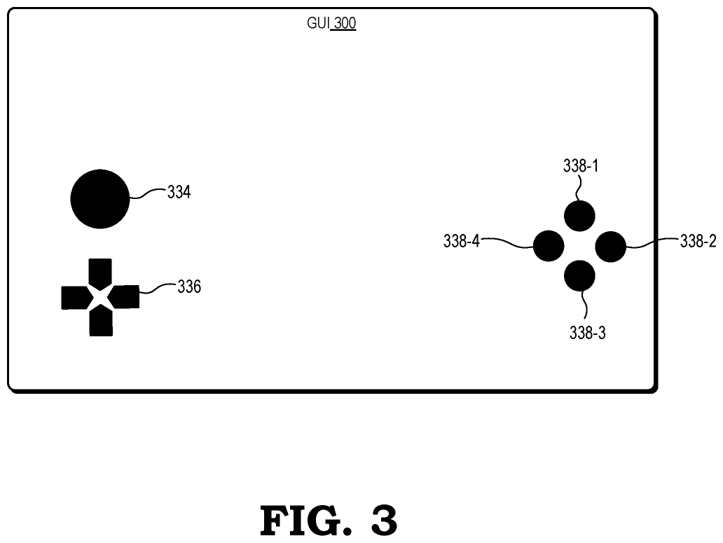

In embodiments, processor 218 executes to operate a virtual controller engine 224 including hardware and software configured to receive one or more interactions, similarly as input devices 216. In embodiments, bridge device 200 includes or is communicatively coupled to a touchscreen (not shown for clarity) configured to receive one or more interactions (e.g., taps, gestures, swipes) and also includes virtual controller engine 224 configured to display a controller GUI on the touch screen. A “controller GUI,” as used herein, is a virtual environment displayed on a touchscreen that includes one or more interactive visual representations of portions of an input device (e.g., icons, text boxes, keys, buttons, directional pads, joysticks, triggers). For example, a controller GUI includes an interactive representation of a directional pad. According to embodiments, virtual controller engine 224 is configured to receive interactions relative to a position of one or more interactive visual representations of portions of an input device within the controller GUI. That is to say, virtual controller engine 224 is configured to receive one or more interactions with the interactive visual representations of portions of an input device. For example, virtual controller engine 224 is configured to receive swipes of an interactive joystick within the controller GUI (i.e., swipes relative to a position of the interactive joystick). As an example, FIG. 3 presents an example embodiment of a controller GUI 300. In the example embodiment, controller GUI 300 is displayed on a touchscreen of bridge device 200 and includes interactive visual representations of portions of an input device that include interactive joystick 334 at a first position within GUI 300, interactive directional pad 336 at a second position within GUI 300, interactive button 338-1 at a third position within GUI 300, interactive button 338-2 at a fourth position within GUI 300, interactive button 338-3 at a fifth position within GUI 300, and interactive button 338-4 at a sixth position of GUI 300. In the example embodiment, virtual controller engine 224 is configured to receive one or more interactions with each of interactive joystick 334, interactive directional pad 336, and interactive buttons 338. As an example, virtual controller engine 224 is configured to receive interactions at the positions of the visual representations of portions of an input device within controller GUI 300, interactions within a threshold distance from the positions of the visual representations of portions of an input device within controller GUI 300, or both.

Referring again to FIG. 2, virtual controller engine 224 is configured to provide data representing interactions with the touch screen, interactions with the interactive visual representations of portions of an input device, or both, to bridge engine 220. In response to receiving the data representing interactions with the touch screen, interactions with the interactive visual representations of portions of an input device, or both from virtual controller engine 224, bridge engine 220 is configured to provide one or more client system inputs to one or more client systems 112 communicatively coupled to bridge device 200 based on the data representing interactions with the touch screen, interactions with the interactive visual representations of portions of an input device, or both. For example, bridge engine 220 is configured to provide the data representing interactions with the touch screen, interactions with the interactive visual representations of portions of an input device, or both to one or more client systems 112 communicatively coupled to bridge device 200. As another example, bridge engine 220 compares the data representing interactions with the touch screen, interactions with the interactive visual representations of portions of an input device, or both to data stored in one or more tables or databases and determines one or more client system inputs based on the comparison. As yet another example, bridge engine 220 provides the data representing interactions with the touch screen, interactions with the interactive visual representations of portions of an input device, or both to one or more lookup tables configured to identify one or more client system inputs.

According to embodiments, bridge engine 220 is configured to generate and transmit a device pair request to one or more servers 102 via network 110. The device pair request includes data requesting the pairing of one or more input devices 216 communicatively coupled to bridge device 200, virtual controller engine 224, or both with one or more gamelet servers running a gaming application for one or more client gaming sessions associated with one or more client systems 112 communicatively coupled to bridge device 200. For example, in response to one or more client systems 112 communicatively coupled to bridge device 200 launching a client gaming session, bridge engine 220 is configured to generate and transmit a device pair request associated with the launched client gaming session. As another example, in response to receiving data representing interactions received at one or more input devices 216 communicatively coupled to bridge device 200, bridge engine 220 is configured to generate and transmit a device pair request based on one or more of the interactions received at the input devices 216 (e.g., based on a client gaming session indicated by the interactions received at the input devices 216). As yet another example, in response to receiving data representing interactions with one or more interactive visual representations of portions of an input device from virtual controller engine 224, bridge engine 220 is configured to generate and transmit a device pair request based on one or more of the interactions with the interactive visual representations of portions of an input device received by virtual controller engine 224 (e.g., based on a gaming application indicated by the interactions received by virtual controller engine 224). In embodiments, the device pair request includes data representing identification information that includes, for example, device identification numbers, client gaming session identifiers, game application information, serial numbers, or any combination thereof. According to embodiments, bridge engine 220 transmits one or more device pair requests each associated with one or more client gaming sessions to one or more device discovery engines 106 running on servers 102. In response to receiving a device pair request, a device discovery engine 106 identifies one or more gamelet servers running game applications to support the client gaming sessions associated with the device pair request. For example, a device discovery engine 106 identifies a gamelet server running a gaming application to support a client gaming session indicated in the device pair request.

After identifying the gamelet servers, a device discovery engine 106 allows access to at least a portion of each of the identified gamelet servers. Device discovery engine 106 allows access to at least a portion of each of the identified gamelet servers by, for example, generating a linking code that identifies a location (e.g., IP address, MAC address port) of the gamelet server and allows access to at least a portion of the gamelet server. In embodiments, device discovery engine 106 is configured to transmit the linking code to one or more client systems 112 communicatively coupled to bridge device 200. For example, device discovery engine 106 transmits the linking code to one or more client systems 112 associated with the client gaming session supported by the gamelet server, one or more client systems 112 identified in the device pair request, or both. According to embodiments, a client system 112 receiving a linking code is configured to display the received linking code. In embodiments, bridge engine 220 is configured to receive the linking code as data transmitted from a device discovery engine 106, data representing interactions with input devices 216 communicatively coupled to bridge device 200, data representing interactions received by virtual controller engine 224, or any combination thereof. In response to receiving the linking code, bridge engine 220 is configured to pair one or more input devices 216 communicatively coupled to bridge device 200, virtual controller engines 224, or both with the gamelet server indicated in the linking code such that interactions received at the paired input devices 216, virtual controller engine 224, or both are provided as inputs to the gamelet server. In other words, bridge engine 220 maintains a connection between the input devices 216 and the gamelet servers so that data representing one or more interactions with the input devices 216 is provided to the gamelet servers for use as inputs to gaming applications running on the gamelet servers 102. In embodiments, bridge engine 220 maintains this connection for at least a portion of the client gaming session supported by the gaming application running on the gamelet server.

In response to receiving the data representing interactions with paired input devices 216, bridge engine 220 is configured to provide one or more game inputs to the gamelet servers paired with the input devices 216 based on the data representing interactions with the input devices 216. “Game inputs,” as used herein, include data representing one or more interactions received by one or more paired input devices 216, game application inputs (e.g., data used in calculations of a gaming application, data used in operations of a gaming application), gaming application commands (e.g., launch gaming application, end gaming application, suspend gaming application), or any combination thereof. According to embodiments, bridge engine 220 determines one or more game inputs based on data representing one or more interactions from the paired input devices 216. For example, bridge engine 220 provides data representing one or more interactions from the paired input devices 216 to one or more software or hardware lookup tables configured to identify one or more game inputs. As another example, bridge engine 220 compares data representing one or more interactions from the paired input devices 216 to data stored in one or more tables, databases, or both, and determines one or more game inputs based on the comparison. Likewise, in response to receiving the data representing interactions with the virtual controller engine 224 (e.g., data representing interactions with a touchscreen, data representing interactions with interactive visual representations of portions of an input device with a controller GUI), bridge engine 220 is configured to provide one or more game inputs to the gamelet servers paired with the input devices 216 based on the data representing interactions with the virtual controller engine 224. According to embodiments, bridge engine 220 determines one or more game inputs based on data representing one or more interactions with virtual controller engine 224. For example, bridge engine 220 provides data representing one or more interactions with virtual controller engine 224 to one or more software or hardware lookup tables configured to identify one or more game inputs. As another example, bridge engine 220 compares data representing one or more interactions with virtual controller engine 224 to data stored in one or more tables, databases, or both, and determines one or more game inputs based on the comparison.

In response to receiving the game inputs, a gamelet server is configured to modify the gaming application running on the gaming platform instance. For example, a gamelet server is configured to provide a game input to an operation of the gaming application running on a gaming platform instance 104. In response to modifying the gaming application running on a gaming platform instance 104, a modified game stream 108 reflecting the modification to the gaming application is transmitted to one or more client systems 112 associated with a client gaming session supported by the gamelet server. In this way, bridge device 200 pairs one or more input devices 216 with one or more gamelet servers so that the input devices 216, virtual controller engine 224, or both are used as inputs (e.g., controllers) of the gaming application running on the gamelet server.

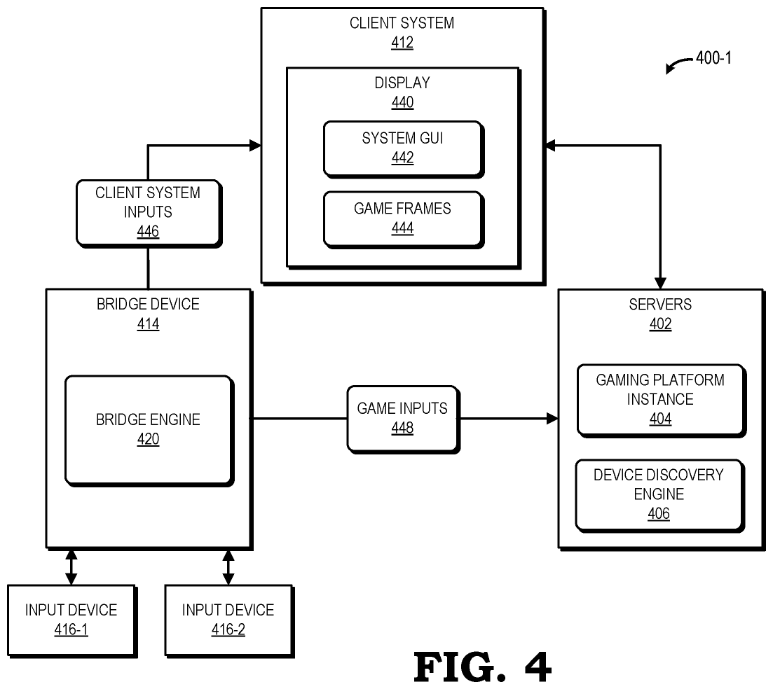

Referring now to FIG. 4, an example system 400-1 for physical input device pairing for cloud-based gaming is presented. System 400-1 includes a bridge device 414, similar to or the same as bridge device 114, 200, communicatively coupled to one or more input devices 416, similar to or the same as input devices 116, 216, and one or more client systems 412, similar to or the same as client systems 112. Though in the illustrative embodiment of FIG. 4, bridge device 414 is communicatively coupled to two input devices (416-1, 416-2) and one client system 412, in other embodiments, bridge device 414 can be communicatively coupled to any number of input devices and any number of client systems 412. In embodiments, bridge engine 420 of bridge device 414 is configured to provide one or more client system inputs 446 to one or more client systems 412 based on data representing interactions with input devices 416. For example, bridge engine 420 compares data representing interactions with input devices 416 to data stored in one or more tables, databases, or both and determines one or more client system inputs 446 based on the comparison. As another example, bridge engine 420 provides the data representing interactions with input devices 416 to one or more lookup tables configured to identify one or more client system inputs 446. As yet another example, bridge engine 420 provides data representing one or more of the interactions with input devices 416 to client systems 412.

According to embodiments, one or more client systems 412 communicatively coupled to bridge device 200 include or are communicatively coupled to a respective display 440. A display 440 includes, for example, one or more cathode-ray tube (CRT), liquid crystal display (LCDs), light-emitting diode (LED), organic light-emitting diode (OLED), and plasma displays. In embodiments, one or more client systems 412 are configured to display a system GUI 442 on a respective display 440. According to embodiments, the system GUI 442 includes visual representations of data (e.g., icons, text boxes, interactive buttons, sliders) representing, for example, identification information (e.g., device identification numbers, client gaming session identifiers, game application information, serial numbers) associated with one or more client gaming sessions, user prompts (e.g., prompts to launch a client gaming session, prompts to select a gaming application, prompts to enter identification information, prompts to initiate device bridge), input device statuses (i.e., battery level of input devices 416, connectivity status of input devices 416, number of input devices 416), or any combination thereof. In embodiments, a client system 412 is configured to modify a system GUI 442 based on one or more client system inputs 446 received from bridge device 414. For example, in response to receiving one or more client system inputs 446, client system 412 is configured to modify one or more visual representations of information within system GUI 442, create new visual representations of information within system GUI 442, eliminate one or more visual representations of information within system GUI 442, or any combination thereof. In this way, bridge device 414 allows input devices 416 to be used as inputs to navigate system GUI 442. In embodiments, in response to receiving one or more client system inputs 446, client system 412 is configured to launch, modify, or end one or more applications, client gaming sessions, or both associated with the client system 112 based on the client system inputs 446. For example, in response to receiving a client system input indicating a client gaming session is to be launched for a gaming application, a client system 412 initiates a client gaming session for that gaming application. During a client gaming session for a gaming application, one or more gamelet servers 402, similar to or the same as servers 102, are configured to render one or more game frames associated with the gaming application and provide a game stream 108 based on the rendered game frames to client system 412. Client system 412 is configured to decode the received game stream 108 to produce decoded game frames 444 that are then displayed on a respective display 440.

In embodiments, bridge engine 420 is configured to initiate pairing of input devices 416 with the server 402 running the gaming application (i.e., gamelet server) in response to the initiation of the client gaming session, a request from a client system 412, receiving data representing interactions with input devices 416, or any combination thereof. For example, bridge engine 420 receives data representing interactions with input devices 416 indicating the initiation of the pairing of the input devices 416 to a gamelet sever 402. To initiate pairing of input devices, bridge engine 420 generates a device pair request including identification data (e.g., identification numbers, client gaming session information, IP addresses, MAC addresses) associated with one or more input devices 416, bridge devices 414, client systems 412, or any combination thereof. For example, bridge engine 420 generates a device pair request including data identifying a client gaming session and an identification number of input device 416-1. In response to generating the device pair request, bridge engine 420 transmits the device pair request to one or more device discovery engines 106 running on one or more servers 402. In response to receiving a device pair request, each device discovery engine 406 is configured to identify one or more gamelet servers 402 running a gaming application on a gaming platform instance 404 supporting a client gaming session associated with the device pair request. For example, bridge engine 420 transmits a device pair request identifying a client gaming session running on client system 412 to a device discovery engine 406. In response to receiving the device pair request, the device discovery engine 406 is configured to identify one or more gamelet servers 402 running a gaming application on a gaming platform instance 404 supporting the client gaming session running on client system 412.

In response to identifying one or more gamelet servers, device discovery engine 406 generates a linking code including locations (e.g., IP address, MAC address port) of the identified gamelet servers and allowing access to at least a portion of each of the identified gamelet servers. In embodiments, device discovery engine 406 is configured to transmit the linking code to one or more client systems 412 associated with the client gaming session, client systems 412 communicatively coupled to bridge device 414, or both. For example, device discovery engine 406 transmits the linking codes to client systems 412 identified in the device pair request received by the device discovery engine 406. In response to receiving a linking code, a client system 412 is configured to display the linking code on a respective display 440. According to embodiments, device discovery engine 406 is configured to transmit the linking code to bridge engine 420. In embodiments, bridge engine 420 is configured to receive the linking code as data transmitted from a device discovery engine 406, as data representing interactions with input devices 416 communicatively coupled to bridge device 200, or both. In response to receiving the linking code, bridge engine 220 is configured to pair one or more input devices 416 with the gamelet servers 402 indicated in the linking code such that interactions received at the paired input devices 416 are provided as inputs to the gamelet servers 402.

In response to pairing one or more input devices 416 with one or more gamelet servers 402, bridge engine 420 is configured to provide one or more game inputs 448 to the paired gamelet servers based on data representing interactions with input devices 416. For example, bridge engine 420 compares data representing interactions with input devices 416 to data stored in one or more tables, databases, or both and determines one or more game inputs 448 based on the comparison. As another example, bridge engine 420 provides the data representing interactions with input devices 416 to one or more lookup tables configured to identify one or more game inputs 448. As yet another example, bridge engine 420 provides data representing one or more of the interactions with input devices 416 to the paired gamelet servers 102.

In response to receiving the game inputs from bridge engine 420, a gamelet server 402 is configured to modify the gaming application running on the gaming platform instance 404 supporting the client gaming session. In embodiments, modifying the gaming application includes providing a game input to an operation of the gaming application running on a gaming platform instance 104 for use in one or more operations of the gaming application. For example, providing one or more game inputs to be used in calculations of the gaming application. As another example, providing one or more game inputs to be used in one or more operations of the gaming application. In response to modifying the gaming application running on a gaming platform instance 404, a modified game stream reflecting the modification to the gaming application is transmitted to one or more client systems 412 associated with the client gaming session supported by the gamelet server 402. The modified stream is then decoded by the client systems 412 to produce one or more game frames 444 that are displayed on a respective display 440. In this way, bridge device 414 pairs one or more input devices 416 with one or more gamelet servers 402 so that the input devices 416 are used as inputs (e.g., controllers) of the gaming application running on the gamelet server 402.

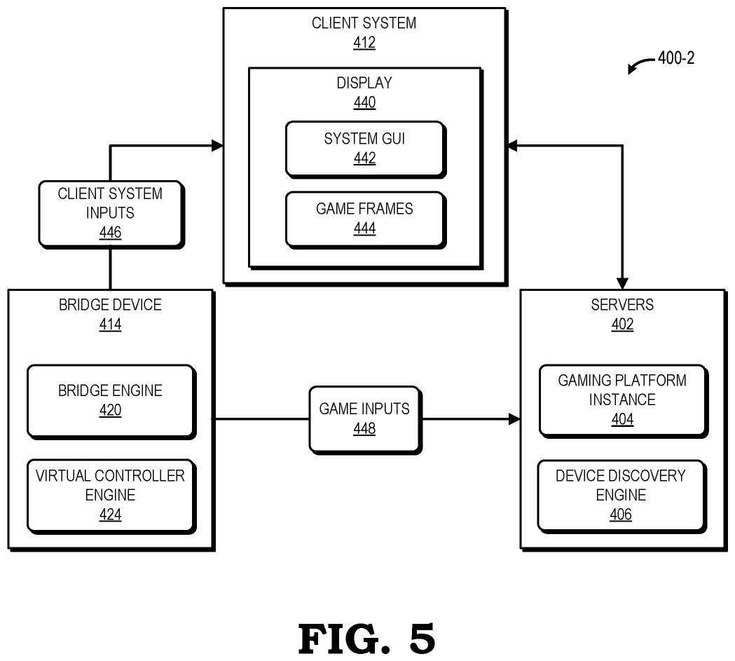

Referring now to FIG. 5, an example system 400-2 for virtual input device pairing for cloud-based gaming is presented. System 400-2 includes a bridge device 414 running a virtual controller engine 424, similar to or the same as virtual controller engine 224, and communicatively coupled to one or more client systems 412. Though in the illustrative embodiment of FIG. 5, bridge device 414 is communicatively coupled to one client system 412, in other embodiments, bridge device 414 can be communicatively coupled to any number of client systems 412. In embodiments, bridge engine 420 of bridge device 414 is configured to provide one or more client system inputs 446 to one or more client systems 412 based on data representing interactions with virtual controller engine 424 (e.g., data representing interactions with a touchscreen, data representing interactions with interactive visual representations of portions of an input device within a controller GUI). For example, bridge engine 420 compares data representing interactions with virtual controller engine 424 to data stored in one or more tables, databases, or both and determines one or more client system inputs 446 based on the comparison. As another example, bridge engine 420 provides the data representing interactions with virtual controller engine 424 to one or more lookup tables to determine one or more client system inputs 446. As yet another example, bridge engine 420 provides data representing one or more of the interactions with the virtual controller engine 424 to client systems 412.

In embodiments, a client system 412 is configured to modify a system GUI 442 based on one or more client system inputs 446 received from bridge device 414. For example, in response to receiving one or more client system inputs 446, client system 412 is configured to modify one or more visual representations of information within system GUI 442, create new visual representations of information within system GUI 442, eliminate one or more visual representations of information within system GUI 442, or any combination thereof. In this way, bridge device 414 allows interactions with virtual controller engine 424 to be used as inputs to navigate system GUI 442. In embodiments, in response to receiving one or more client system inputs 446, client system 412 is configured to launch, modify, or end one or more applications, client gaming sessions, or both associated with the client system 112 based on the client system inputs 446. For example, in response to receiving a client system input indicating a client gaming session is to be launched for a gaming application, a client system 412 initiates a client gaming session for that gaming application.

According to embodiments, bridge engine 420 is configured to initiate pairing of virtual controller engine 424 with the server 402 running the gaming application supporting the client gaming session (i.e., gamelet server) in response to the initiation of the client gaming session, a request from a client system 412, receiving data representing interactions with virtual controller engine 424 or any combination thereof. For example, bridge engine 420 receives data representing interactions with virtual controller engine 424 indicating the initiation of the pairing of virtual controller engine 424 to a gamelet sever 402. To initiate pairing, bridge engine 420 generates a device pair request including identification data (e.g., identification numbers, client gaming session information, IP addresses, MAC addresses) associated with virtual controller engine 424, bridge devices 414, client systems 412, or any combination thereof. For example, bridge engine 420 generates a device pair request including data identifying a client gaming session and an IP address of bridge device 414. In response to generating the device pair request, bridge engine 420 transmits the device pair request to one or more device discovery engines 106 running on one or more servers 402. In response to receiving a device pair request, each device discovery engine 406 is configured to identify one or more gamelet servers 402 running a gaming application on a gaming platform instance 404 supporting a client gaming session associated with the device pair request.

In response to identifying one or more gamelet servers, device discovery engine 406 generates a linking code that includes locations (e.g., IP address, MAC address port) of the identified gamelet servers and allows access to at least a portion of each of the identified gamelet servers. In embodiments, device discovery engine 406 is configured to transmit the linking code to one or more client systems 412 associated with the client gaming session, client systems 412 communicatively coupled to bridge device 414, or both. For example, device discovery engine 406 transmits the linking codes to client systems 112 identified in the device pair request received by the device discovery engine 406. In response to receiving a linking code, a client system 412 is configured to display the linking code on a respective display 440. According to embodiments, device discovery engine 406 is configured to transmit the linking code to bridge engine 420. In embodiments, bridge engine 420 is configured to receive the linking code as data transmitted from a device discovery engine 406, data representing interactions with virtual controller engine 424, or both. In response to receiving the linking code, bridge engine 220 is configured to pair virtual controller engine 424 with the gamelet servers 402 indicated in the linking code such that interactions received at the virtual controller engine 424 are provided as inputs to the gamelet server.

In response to pairing virtual controller engine 424 with one or more gamelet servers 402, bridge engine 420 is configured to provide one or more game inputs 448 to the paired gamelet servers based on data representing interactions virtual controller engine 424. For example, bridge engine 420 compares data representing interactions with virtual controller engine 424 to data stored in one or more tables, databases, or both and determines one or more game inputs 448 based on the comparison. As another example, bridge engine 420 provides the data representing interactions with virtual controller engine 424 to one or more lookup tables configured to identify one or more game inputs 448. As yet another example, bridge engine 420 provides data representing one or more of the interactions with virtual controller engine 424 to the paired gamelet servers 402.

In response to receiving the game inputs from bridge engine 420, a gamelet server 402 is configured to modify the gaming application running on the gaming platform instance 404 supporting the client gaming session. In response to modifying the gaming application running on a gaming platform instance 404, a modified game stream reflecting the modification to the gaming application is transmitted to one or more client systems 412 associated with the client gaming session supported by the gamelet server 402. The modified stream is then decoded by the client systems 412 to produce one or more game frames 444 that are displayed on a respective display 440. In this way, bridge device 414 pairs virtual controller engine 424 with one or more gamelet servers 402 so that the virtual controller engine 424 is used as an input device (e.g., controller) of the gaming application running on the gamelet server 402.

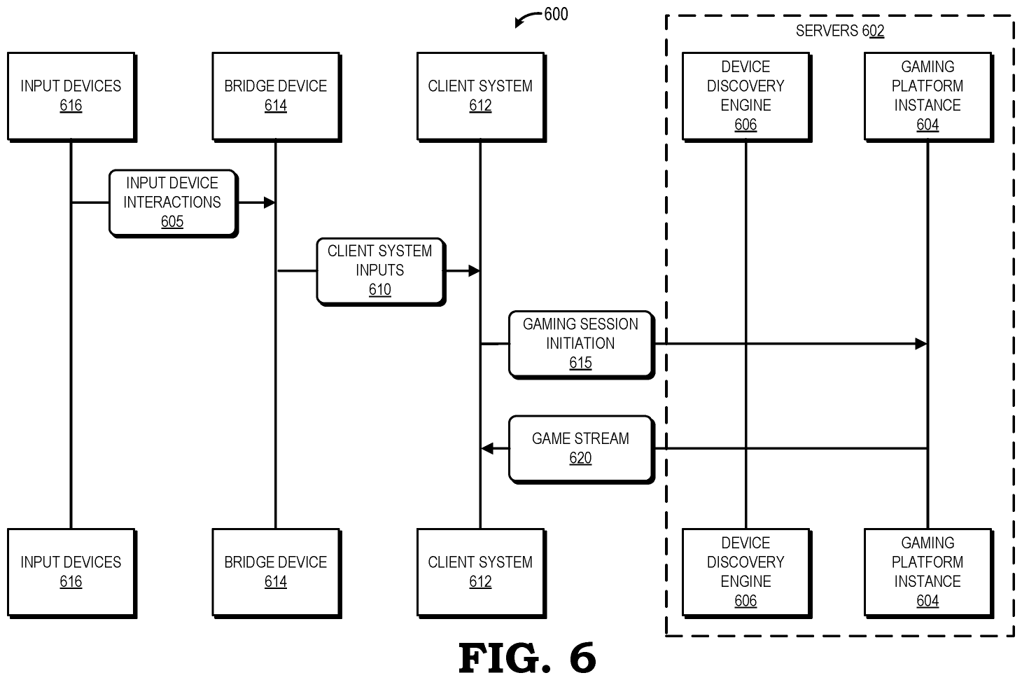

Referring now to FIGS. 6 to 8, a signal flow diagrams together illustrating an example pairing operation 600 for pairing one or more input devices 616, similar to or the same as input devices 116, 216, 416, with one or more gamelet servers 602, similar to or the same as servers 102, 402, running a gaming application to support a client gaming session is presented. In embodiments, at least a portion of the pairing operation 600 is operable on a bridge device 614, similar to or the same as bridge device 114, 200, 414, communicatively coupled to one or more input devices 616 and one or more client systems 612, similar to or the same as client system 112, 412. In embodiments, input devices 616 include one or more physical input devices (e.g., physical keyboards, mice, wearable virtual reality client devices, physical game controllers, smartphones), virtual input devices (e.g., virtual controller engines 224, 424), or both. Referring now to FIG. 6, the pairing operation 600 includes one or more input devices 616 receiving one or more interactions (e.g., gestures on a touch screen, button presses, joystick movements, keystrokes, mouse clicks, mouse drags, device movements) and providing data representing these interactions (i.e., input device interactions 605) to bridge device 614. In response to receiving the input device interactions 605, bridge device 614 determines one or more client system inputs 610. For example, bridge device 614 compares the input device interactions 605 to one or more tables or databases and determines one or more client system inputs 610 based on the comparison. As another example, bridge device 614 provides the input device interactions 605 to one or more lookup tables configured to identify one or more client system inputs 610. In embodiments, client system inputs 610 include, for example, data representing input device interactions 605, application inputs (e.g., data used in calculations of an application, data used in operations of an application), application commands (e.g., launch application, end application, suspend application), client system commands (e.g., power down, enter sleep state, restart), or any combination thereof. After determining one or more client system inputs 610, bridge device 614 provides the client system inputs 610 to one or more client systems 612.

According to embodiments, in response to receiving the client system inputs 610, a client system 612 is configured to initiate a gaming session based on the input device interactions 605. For example, a client system 612 receives client system inputs 610 indicating that a client gaming session for a gaming application is to be launched. In response to these client system inputs 610, client system 612 generates and transmits a client gaming session initiation 615 to one or more servers 602. A “gaming session initiation,” as used herein, includes data requesting a client gaming session for a specified game application and identification information related to the client system 612 (e.g., IP address, MAC address). In response to receiving client gaming session initiation 615, a gamelet server 602 launches a gaming platform instance 604 to operate at least a portion of the gaming application indicated by the gaming session initiation. In embodiments, the gaming platform instance 604 of the gamelet server 602 renders one or more game frames related to the gaming application and encodes them into game stream 620. The gaming platform instance 604 of the gamelet server 602 then transmits the game stream 620 to the client system 612 that sent the client gaming session initiation 615. In response to receiving the game stream 620, the client system 612 decodes the game stream into one or more decoded game frames and displays the decoded game frames.

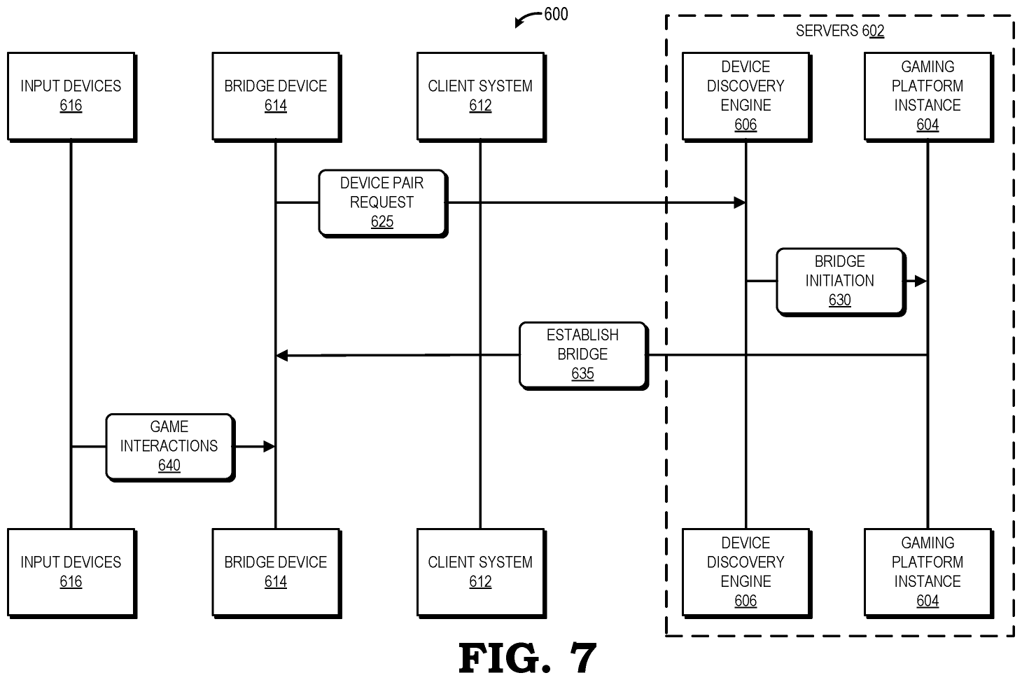

Referring now to FIG. 7, the pairing operation 600 is continued. The pairing operation 600 included bridge device 614 generating a device pair request 625 that includes data requesting the pairing of one or more input devices 616 with the gamelet server 602 running the gaming application on the gaming platform instance 604. That is to say, the device pair request 625 includes data requesting that one or more physical input devices, virtual controller engines, or both be paired with one or more gamelet servers running a gaming application for one or more client gaming sessions associated with client system 612. According to embodiments, bridge device 614 generates the device pair request in response to client system 612 launching a client gaming session, to receiving data representing interactions received at one or more input devices 616, or both. In embodiments, the device pair request 625 includes data representing identification information related to input devices 616, bridge device 614, client system 612, or any combination thereof, for example, device identification numbers, client gaming session identifiers, game application information, serial numbers, or any combination thereof. In response to generating the device pair request 625, bridge device 614 transmits the device pair request to one or more device discovery engines 606 operating on one or more servers 602.

In response to receiving the device pair request 625, a device discovery engine 606 identifies one or more gamelet servers 602 operating a game application on a gaming platform instance 604 to support a client gaming session indicated by the device pair request. For example, based on the device pair request 625, device discovery engine 606 determines a client gaming session associated with the device pair request 625. Device discovery engine 606 then identifies one or more gamelet servers 602 operating a game application on a gaming platform instance 604 to support the determined client gaming session. In response to identifying one or more gamelet servers 602 supporting the client gaming session, generates and transmits an establish bridge command 635 to bridge device 614. A “bridge command,” as used herein includes data necessary for, aiding in, or helpful for the pairing of one or more input devices 616 to one or more gamelet servers 602. For example, a bridge command includes one or more linking codes, prompts, identification information, or any combination thereof. In embodiments, the establish bridge command 635 includes a linking code and one or more user prompts. For example, the establish bridge command 635 includes a linking code and one or more prompts including visual data prompting a user to enter in the linking code. According to embodiments, a linking code includes data indicating locations (e.g., IP address, MAC address port) of the identified gamelet servers 602 and data allowing access to at least a portion of each of the identified gamelet servers 602. In embodiments, at least a portion of the establish bridge command 635 is transmitted to client system 612. For example, a linking code and user prompt is transmitted to client system 612. In response to receiving at least a portion of the establish bridge command 635, the client system 612 displays the portion of the establish bridge command 635. For example, the client system displays the linking code and a user prompt.

In embodiments, after a device discovery engine 606 has generated the establish bridge command 635, bridge device 614 receives one or more linking codes as at least a received portion of an establish bridge command 635, interactions with input devices 616, or both. For example, bridge device 614 receives data representing one or more interactions with input devices 616 that indicate one or more linking codes. In response to receiving one or more linking codes, bridge device 614 pairs one or more input devices 616 with one or more gamelet servers 602 indicated by the linking codes such that the input devices 616 are used as input devices (e.g., controllers) for the gaming application running on the gaming platform instance 604 of the gamelet server 602. After one or more input devices 616 are paired with one or more gamelet servers, one or more paired input devices 616 receive one or more game interactions. That is to say, the paired input devices 616 receive one or more interactions while one or more game frames are displayed by client system 612. In embodiments, the paired input devices 616 provide data representing these interactions (i.e., game interactions 640) to bridge device 614.

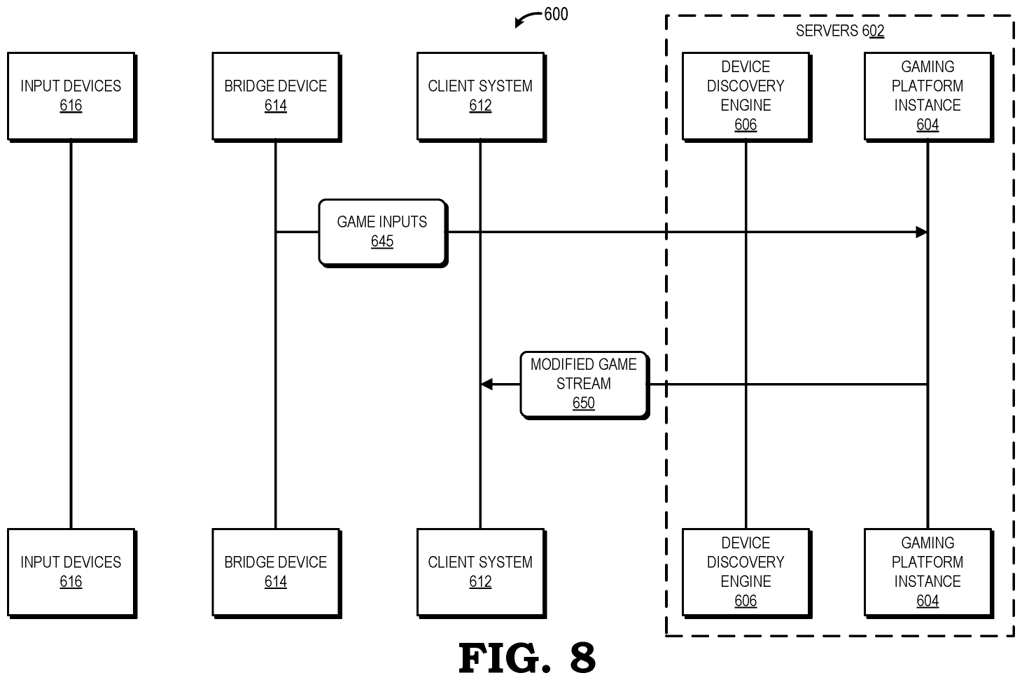

Referring now to FIG. 8, the pairing operation 600 is continued. In embodiments, in response to receiving one or more game interactions 640 from paired input devices 616, bridge device 614 determines one or more game inputs 645. For example, bridge device 614 compares the game interactions 640 to one or more tables or databases and determines one or more game inputs 645 based on the comparison. As another example, bridge device 614 provides the game interactions 640 to one or more lookup tables configured to identify one or more game inputs 645. In embodiments, game inputs 645 include, for example, data representing game interactions 630, gaming application inputs (e.g., data used in calculations of a gaming application, data used in operations of a gaming application), gaming application commands (e.g., launch gaming application, end gaming application, suspend gaming application), or any combination thereof. After determining one or more game inputs 645, bridge device 614 provides the game inputs 645 to one or more gamelet servers 602 paired with the paired input devices 616. In response to receiving one or more game inputs 645, a gamelet server 602 is configured to modify the gaming application running on a gaming platform instance 604 based on the game inputs 645. Modifying the gaming application includes, for example, providing one or more game inputs 645 to gaming platform instance 604 to be used in an operation of the gaming application, providing one or more game inputs 645 to gaming platform instance 604 to be used in a calculation of the gaming application, suspending a gaming application, ending a gaming application, launching a gaming application, or any combination thereof. In response to modifying the gaming application, the gaming platform instance 604 renders one or more game frames reflecting the modifications to the gaming application. For example, the gaming platform instance 604 renders game frames reflecting one or more calculations made using one or more game inputs 645. The gaming platform instance then encodes the modified game frames into a modified game stream 650 that is transmitted to client system 612. In response to receiving the modified game stream 650, the client system 612 decodes the modified game stream 650 and displayed one or more decoded game frames. In this way, one or more input devices 616 are paired with one or more gamelet servers 602 running gaming applications such that the paired input devices are used as controllers for the gaming applications (i.e., used to provide inputs to the gaming applications).

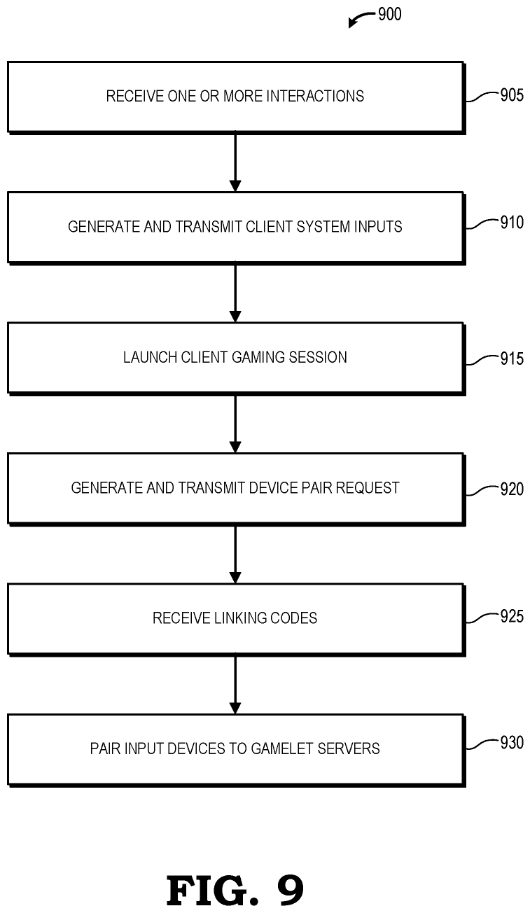

Referring now to FIG. 9, a flow chart of an example method 900 for pairing one or more input devices with one or more gamelet servers is illustrated. At step 905, a bridge device, similar to or the same as bridge devices 114, 200, 414, 614, communicatively couples to one or more input devices, similar to or the same as input devices 116, 216, 416, 616, and one or more client systems, similar to or the same as client systems 112, 412, 612. In embodiments, the input devices communicatively coupled to the bridge device include physical input devices (e.g., keyboards, mice, wearable virtual reality client devices, game controllers, smartphones), virtual input devices (e.g., virtual controller engines 224, 424), or both. According to embodiments, the bridge device is configured to receive data representing one or more interactions (e.g., gestures on a touch screen, button presses, joystick movements, keystrokes, mouse clicks, mouse drags, device movements) with the communicatively coupled input devices from the communicatively coupled input devices. For example, the bridge device is configured to receive data representing button presses from a control pad communicatively connected to the bridge device. At step 910, in response to receiving data representing interactions with the input devices, the bridge device generates and transmits client system inputs, similar to or the same as client system inputs 610, based on the received data representing the interactions with the input device. For example, in response to receiving data representing interactions with the input devices, the bridge device compares the received data representing interactions to data stored in one or more tables or databases and generates one or more client system inputs based on the comparison. As another example, in response to receiving data representing interactions with the input devices, the bridge device provides the data representing the interactions to one or more lookup tables configured to identify one or more client system inputs. The client system inputs include, for example, data representing one or more interactions received by the input devices, application information, application commands, client system commands, or any combination thereof. In embodiments, the bridge device transmits the client system inputs to one or more client systems communicatively coupled to the bridge device. According to embodiments, transmitting the client system inputs to the client systems includes transmitting the data representing the interactions with the input devices to the client systems.

At step 915, one or more client systems launch one or more client gaming sessions. For example, in response to receiving data representing the interactions with the input devices indicating the initiation of a client gaming session, a client gaming session requests the initiation of a client gaming session from one or more servers, similar to or the same as servers 102, 402, 602. In response to receiving a request for the initiation of a client gaming session, a gamelet server is configured to run a gaming application on a gaming platform instance, similar to or the same as gaming platform instance 104, 404, 604, to support the client gaming session. While the gaming application is running on the gaming platform instance, the gaming platform instance renders one or more game frames and encodes the frames into a game stream, similar to or the same as game stream 108, which is transmitted to the client system for display. At step 920, the bridge device generates a device pair request, similar to or the same as device pair request 625. In embodiments, the bridge device generates the device pair request in response to the launching of the client gaming session. According to embodiments, the bridge device generates the device pair request in response to data representing one or more interactions with the input devices communicatively coupled to the bridge device. For example, the bridge device generates the device pair request in response to receiving data representing an interaction with an input device indicating a request for device pairing. The device pair request includes data requesting that one or more input devices (e.g., physical input devices, virtual controller engines, or both) communicatively coupled to the bridge device be paired with the gamelet servers running a gaming application to support the launched client gaming session. For example, the device pair request includes data representing identification information related to the bridge device, input devices communicatively coupled to the bridge device, the client systems communicatively coupled to the bridge device, or any combination thereof. Such identification information includes, for example, device identification numbers, client gaming session identifiers, game application information, serial numbers, or any combination thereof. In embodiments, the bridge device transmits the device pair request to one or more device discovery engines, similar to or the same as device discovery engine 106, 406, 606, running on servers 102 via a network, similar to or the same as network 110.

At step 925, in response to receiving a device pair request, a device discovery engine operating on a server identifies one or more gamelet servers based on the device pair request. For example, the device discovery engine identifies one or more gamelet servers running a gaming application to support one or more client gaming sessions indicated in the device pair request. In response to identifying one or more gamelet servers, the device discovery engine generates one or more linking codes that identify one or more locations (e.g., IP address, MAC address port) of the identified gamelet servers and allows access to at least a portion of each of the identified gamelet servers. In embodiments, the device discovery engine transmits the linking codes and one or more user prompts to a client system associated with the client gaming session. For example, the device discovery engine transmits a linking code and a user prompt to enter the linking code to one or more client systems associated with the client gaming session indicated by the device pair request. In response to receiving the linking code and user prompts, the client system is configured to display the linking codes and user prompts. According to embodiments, the bridge device is configured to receive one or more linking codes as data transmitted from one or more device discovery engines, as data provided from input devices communicatively coupled to the bridge device representing interactions with the input devices, or both. For example, the bridge device is configured to receive data representing interactions with input devices indicating a linking code.

At step 930, in response to receiving a linking code, the bridge device is configured to pair one or more input devices communicatively coupled to the bridge device with the gamelet servers indicated by the linking code. According to embodiments, the bridge device is configured to pair the input devices and gamelet servers such that the input devices communicatively coupled to the bridge device function as input devices (e.g., controllers) for the gaming application running on the gamelet servers. In embodiments, the bridge device is configured to determine one or more game inputs, similar to or the same as game inputs 448, 645, based on data representing interactions with the paired input devices. For example, in response to receiving data representing interactions with the paired input devices, the bridge device compares the received data representing the interactions to data stored in one or more stables or databases and determines one or more game inputs based on the comparison. As another example, in response to receiving data representing interactions with the paired input devices, the bridge device provides the data representing the interactions to one or more lookup tables configured to identify one or more game inputs. The bridge device then transmits the game inputs to the paired gamelet servers for use as inputs to one or more gaming applications. In embodiments, transmitting the game inputs includes providing the data representing interactions with the paired input devices to the paired gamelet servers.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

The preposition “or” as used in the context of “at least one of A, B, or C”, is herein used to signify an “inclusive or.” That is to say, in the above and similar contexts, or is used to signify “at least one of or any combination thereof.” For example, “at least one of A, B, and C” is used to signify “at least one of A, B, C, or any combination thereof.”

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method for cloud-based gaming comprising:
communicatively coupling at least one physical game controller to a bridge device, the bridge device configured to pair the at least one physical game controller with at least one cloud-based gaming server;
transmitting, to the at least one cloud-based gaming server, a device pair request to establish the at least one physical game controller as an input device for a gaming application running on the at least one cloud-based gaming server and associated with a client gaming session; and
in response to receiving a linking code, maintaining, for at least a portion of the client gaming session, a connection between the at least one physical game controller and the at least one cloud-based gaming server so that data representing one or more interactions with the at least one physical game controller is provided to the at least one cloud-based gaming server for use as inputs to the gaming application.

2. The method of claim 1, wherein the bridge device includes a smartphone.

3. The method of claim 2, further comprising communicatively coupling a client system associated with the client gaming session to the bridge device.

4. The method of claim 3, further comprising:
transmitting data representing an interaction with the at least one physical game controller to the client system associated with the client gaming session.

5. The method of claim 4, further comprising:
In response to receiving the interaction with the at least one physical game controller, modifying a graphical user interface displayed on the client system.

6. The method of claim 4, further comprising:
determining one or more client system inputs based on the interaction with the at least one physical game controller.

7. The method claim 1, further comprising:
receiving a linking code associated with the at least one cloud-based gaming server; and
establishing the connection between the at least one physical game controller and the at least one cloud-based gaming server based on the linking code.

8. The method of claim 7, further comprising:
receiving data representing an interaction with the at least one physical game controller indicating the linking code.

9. The method of claim 1, further comprising:
identifying, based on the device pair request and by a device discovery engine of a cloud-based gaming system, one or more gamelet servers of the cloud-based gaming system running the gaming application to support the client gaming session.

10. The method of claim 9, wherein, in response to identifying the one or more gamelet servers, the device discovery engine generates the linking code identifying the one or more gamelet servers and allowing access to at least a portion of the one or more gamelet servers.

11. The method of claim 1, further comprising:
determining one or more game inputs based on the data representing one or more interactions with the at least one physical game controller; and
providing the game inputs to the at least one cloud-based gaming server.

12. A method for cloud-based gaming, comprising:
receiving, at at least one cloud-based gaming server, a device pair request associated with a client gaming session from a bridge device communicatively coupled to at least one physical game controller;
identifying at least one gamelet server running a gaming application to support the client gaming session; and
pairing the identified at least one gamelet server with the at least one physical game controller such that data representing one or more interactions with the at least one physical game controller is provided to the at least one gamelet server for use as inputs to the gaming application running on the at least one gamelet server.

13. The method of claim 12, further comprising:
in response to receiving a client gaming session request, launching the client gaming session.

14. The method of claim 13, wherein launching the client gaming session includes running the gaming application on the at least one gamelet server.

15. The method of claim 12, further comprising:
rendering a plurality of game frames associated with the gaming application; and
encoding the plurality of game frames to produce a game stream.

16. The method of claim 15, further comprising:
transmitting the game stream to a client system associated with the client gaming session.

17. The method of claim 12, further comprising:
modifying the gaming application running on the at least one gamelet server based on the data representing one or more interactions with the at least one physical game controller.

18. The method of claim 16, wherein modifying the gaming application comprises providing data representing an interaction received by the at least one physical game controller as an input to a calculation of the gaming application.

19. The method of claim 12, further comprising:
in response to receiving data representing an interaction with the at least one physical game controller, suspending the gaming application.

20. The method of claim 12, further comprising:
rendering a plurality of modified game frames based on the data representing one or more interactions with the at least one physical game controller; and
encoding the plurality of modified game frames to produce a modified game stream.

21. The method of claim 20, further comprising:
transmitting the modified game stream to a client system associated with the client gaming session.

22. The method of claim 12, further comprising:
generating a linking code based on the identified at least one gamelet server.

23. The method of claim 22, wherein pairing the identified at least one gamelet server with the at least one physical game controller is based on the linking code.

24. (canceled)

25. (canceled)

26. (canceled)

28. (canceled)

29. (canceled)

30. (canceled)
